(19) United States
(12) Patent Application Publication
(10) Pub. No.: US 2011/0199682 A1
(43) Pub. Date: Aug. 18, 2011

(54) BEAM COMBINER

(75) Inventor: Te-Wei Liu, Taichung (TW)

(73) Assignee: ASIA OPTICAL CO., INC., Taichung (TW)

(21) Appl. No.: 13/010,384

(22) Filed: Jan. 20, 2011

(30) Foreign Application Priority Data
Feb. 12, 2010 (TW) 99104650

(51) Int. Cl. G02B 27/10; G02B 27/28

(52) U.S. Cl. 359/492.01

(57) ABSTRACT

The present invention provides a small and light beam combiner to be mounted in a micro-projector. The combiner includes a splitting film, a polarization rotator, and an edge filter film. The polarization rotator is next to the splitting film to rotate a polarization angle of a polarized light. An angle between the splitting film and the polarization rotator is about 45 degrees. The edge filter film is coated on the polarization rotator that the polarization rotator is between the splitting film and the edge filter film.

### BACKGROUND OF THE INVENTION

1. Field of the Invention

The present invention relates generally to a beam combiner, and more particularly to a light and small RGB beam combiner.

2. Description of the Related Art

Typically, a projector has a RGB beam combiner to combine and output beams.

For example, as shown in FIG. 1, a conventional RGB beam combiner 1 includes a reflector 10, a first prism 21 and a second prism 22.

The reflector 10 and the first and second prisms 21, 22 are arranged in sequence. The first and second prisms 21, 22 have a first splitting film 21a and a second splitting film 22a respectively. The first and second splitting films 21a, 22a are dichroic splitting films.

As shown in FIG. 1, suppose there are three parallel beams (a first beam L1, a second beam L2, and a third beam L3) with different wavelengths entering the conventional combiner 1, the first beam L1 transmits to the reflector 10 to be reflected, and then transmits through the first and second prisms 21, 22 in sequence and out of the combiner 1 via an output 30. The second beam L2 transmits to the first prism 21 to be reflected by the first splitting film 21a, and then transmits through the second prism 22 and out via the output end 30. The third beam L3 transmits to the second prism 22 to be reflected by the second splitting film 22a, and then comes out via the output end 30. The beams L1, L2, L3 are combined behind the second prism 22.

The conventional beam combiner 1 equipped with the reflector 10 and the first and second prisms 21, 22 is too huge and heavy for a micro-projector.

### SUMMARY OF THE INVENTION

The primary objective of the present invention is to provide a smaller and lighter beam combiner.

According to the objective of the present invention, a beam combiner of the present invention is incorporated in a micro-projector including a splitting film, a polarization rotator, and an edge filter film. The polarization rotator is next to the splitting film to rotate a polarization angle of a polarized light. An angle between the splitting film and the polarization rotator is 45 degrees. The edge filter film is coated on the polarization rotator that the polarization rotator is between the splitting film and the edge filter film.

In an embodiment, the combiner further includes a prism next to the polarization rotator in which the splitting film is provided.

In an embodiment, the combiner further includes a transparent plate next to the polarization rotator on which the splitting film is provided.

In an embodiment, the splitting film has both functions of the dichroic splitting film and the polarized splitting film to reflect S-polarized light and allow P-polarized light to transmit through. At the same time, the splitting film may reflect a second beam and allow a third beam to transmit through.

### BRIEF DESCRIPTION OF THE DRAWINGS

FIG. 1 is a sectional view of the conventional RGB beam combiner;

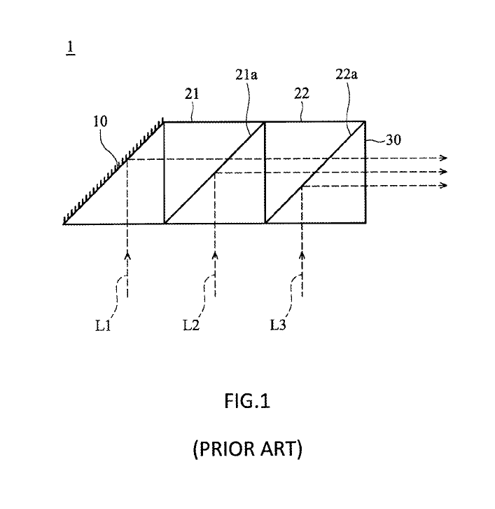

FIG. 2 is a sectional view of a first preferred embodiment of the present invention;

FIG. 3 is a sectional view of a second preferred embodiment of the present invention; and

FIG. 4 is a sectional view of a third preferred embodiment of the present invention.

### DETAILED DESCRIPTION OF THE INVENTION

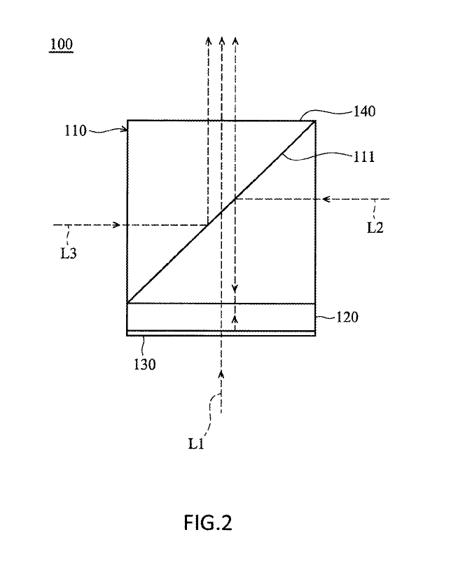

As shown in FIG. 2, a beam combiner 100 of the first preferred embodiment of the present invention includes a prism 110, a polarization rotator 120, and an edge filter film 130.

The prism 110 has a splitting film 111 coated thereon. The splitting film 111 is a specialized optical film having both functions of the dichroic splitting film and the polarized splitting film that the splitting film 111 may reflect the second beam L2 of S-polarized light and allow P-polarized light to transmit through. At the same time, the splitting film 111 may reflect a third beam L3 and allow a first beam L1 to transmit through.

The polarization rotator 120 is adjacent to the splitting film 111 with a 45 degrees angle between the splitting film 111 and the polarization rotator 120. The polarization rotator 120 may rotate a polarization angle of polarized light. In the present embodiment, the polarization rotator 120 is a ¼ waveplate.

The edge filter film 130 is coated on the polarization rotator 120. In the present embodiment, the polarization rotator 120 is between the splitting film 111 and the edge filter film 130. The edge filter film 130 reflects the beam with a wavelength in a specific range and allows the beam in another wavelength range to transmit through. In other words, the first beam L1 transmits through the edge filter film 130 and the second beam L2 is reflected by the edge filter film 130 when the incident angles of the beams are 0 degree.

As shown in FIG. 2, the combiner 100 has four sides, in which three of them, including the side having the edge filter film 130, the side pointing to the splitting film 111 and the side at a side of the prism 110, are entrances of beams, and the other one, the other side of the prism 111, is an output 140 of combined beam.

As shown in FIG. 2, three beams, including a first beam L1 with a first wavelength, a second beam L2 with a second wavelength, and a third beam L3 with a third wavelength, transmit to the combiner 100 of the present invention from the three entrances respectively. A direction of the first beam L1 entering the combiner 100 is perpendicular to the second beam L2 and the third beam L3 respectively. The first beam L1 is non-polarized light or P-polarized light, the second beam L2 is S-polarized light, and the third beam L3 is non-polarized light or S-polarized light that the first beam L1 transmits through the edge filter film 130 and the second beam L2 is reflected by the edge filter film 130 when incident angles of the beams are 0 degree.

In consideration of the first beam L1, it transmits through the edge filter film 130, the polarization rotator 120, and the splitting film 111 of the prism 110 in sequence and transmits out of the combiner 100″ via the output 140.

In consideration of the second beam L2, it transmits to the splitting film 111 of the prism 110 with an incident angle of 45 degrees and is reflected because the second beam L2 is S-polarized light. After refection, the second beam L2 transmits into the polarization rotator 120 and is reflected by the edge filter film 130 and transmits through the polarization rotator 120. As a result, the second beam L2 has a 90 degrees phase delay to be converted into P-polarized light after leaving the polarization rotator 120 because it transmits through the polarization rotator 120 twice. Next, the second beam L2 transmits through the splitting film 111 because it is P-polarized light and finally out of the combiner 100 via the output 140.

In consideration of the third beam L3, it transmits through the prism 110 to the splitting film 111 with an incident angle of 45 degrees. The third beam L3 is reflected by the splitting film 111 because it is S-polarized light, and then the third beam L3 transmits out of the combiner 100 via the output 140.

The three beams L1, L2, L3 are combined at or after the output 140.

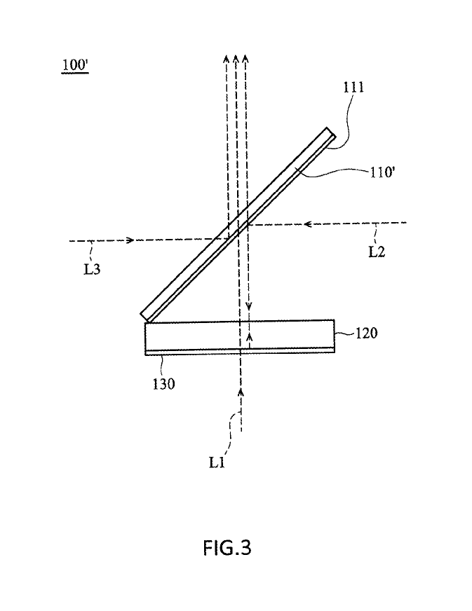

FIG. 3 shows a beam combiner 100′ of the second preferred embodiment of the present invention including a transparent plate 110′, a splitting film 111, a polarization rotator 120, and an edge filter film 130.

The splitting film 111 is coated on the transparent plate 110′. Same as the first preferred embodiment, the splitting film 111 is a specialized optical film having both functions of the dichroic splitting film and the polarized splitting film that the splitting film 111 may reflect the second beam L2 of S-polarized light and allow P-polarized light to transmit through. At the same time, the splitting film 111 may reflect the third beam L3 and allow the first beam L1 to transmit through.

The polarization rotator 120 is adjacent to the splitting film 111 with a 45 degrees angle between the splitting film 111 and the polarization rotator 120. The polarization rotator 120 may rotate a polarization angle of polarized light.

The second preferred embodiment provides the transparent plate 110′ to replace the prism 110 of the first preferred embodiment. The rest elements and functions are the same as the first preferred embodiment, so we do not describe them again.

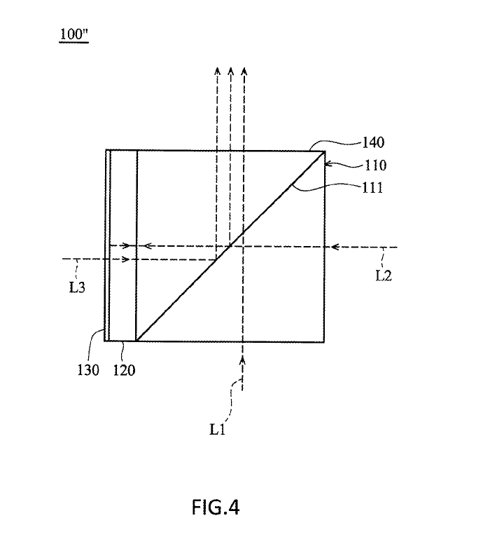

FIG. 4 shows a beam combiner 100″ of the third preferred embodiment of the present invention including a prism 110, a polarization rotator 120, and an edge filter film 130.

The prism 110 is a prism having a splitting film 111 coated thereon. The splitting film 111 is a specialized optical film having both functions of the dichroic splitting film and the polarized splitting film that the splitting film 111 may reflect the second beam L2 of S-polarized light and allow P-polarized light to transmit through. At the same time, the splitting film 111 may reflect the third beam L3 and allow the first beam L1 to transmit through.

The edge filter film 130 is coated on the polarization rotator 120. In the present embodiment, the polarization rotator 120 is between the prism 110 and the edge filter film 130, and the prism 110 is between the splitting film 111 and the polarization rotator 120. The edge filter film 130 reflects the beam with a wavelength in a specific range and allows the beam in another wavelength range to transmit through. In other words, the first beam L1 transmits through the edge filter film 130 and the second beam L2 is reflected by the edge filter film 130 when the incident angles of the beams are 0 degree.

The other elements of the combiner 100″ of the third preferred embodiment are the same as the first preferred embodiment, so we do not describe them again.

The combiner 100″ of the third preferred embodiment has three entrances and an output 140. Two of entrances point the splitting film 111 in perpendicular directions and the third entrance is at the side of edge filter film 130.

As shown in FIG. 4, three beams, including a first beam L1 with a first wavelength, a second beam L2 with a second wavelength, and a third beam L3 with a third wavelength, transmit to the combiner 100″ from three entrances. A direction of the first beam L1 entering the combiner 100″ is perpendicular to the second beam L2 and the third beam L3 respectively. The first beam L1 is non-polarized light or P-polarized light, the second beam L2 is P-polarized light, and the third beam L3 is non-polarized light or S-polarized light that the first beam L1 transmits through the edge filter film 130 and the second beam L2 is reflected by the edge filter film 130 when incident angles of the beams are 0 degree.

In consideration of the first beam L1, it transmits through the splitting film 111 of the prism 110 and out of the combiner 100″ via the output 140 directly without any reflection.

In consideration of the second beam L2, it transmits through the splitting film 111 of the prism 110 with an incident angle of 45 degrees because it is P-polarized light. After transmitting through the splitting film 111, the second beam L2 transmits though the prism 110 and into the polarization rotator 120. Next, the second beam L2 is reflected by the edge filter film 130 and transmits through the polarization rotator 120. After leaving the polarization rotator 120, the second beam L2 has a 90 degrees phase delay and is converted into S-polarized light because it transmits through the polarization rotator 120 twice. Next, the second beam L2 of S-polarized light transmits through the prism 110 to the splitting film 111 with an incident angle of 45 degrees again to be reflected and transmits out of the combiner 100″ via the output 140.

In consideration of the third beam L3, it transmits through the edge filter film 130, the polarization rotator 120, and the prism 110 in sequence to the splitting film 111 with an incident angle of 45 degrees. The third beam L3 is reflected by the splitting film 111 and transmits out of the combiner 100″ via the output 140.

In conclusion, only one prism is needed in the present invention (it has two prisms in the conventional device) that the beam combiner of the present invention is lighter and smaller than the conventional combiner to be incorporated in a micro-projector easily. It is easy and simple to assemble the beam combiner of the present invention that the yield rate in manufacture of the combiner of the present invention is increased without raising the manufacturing cost. In addition, the number of the elements in the beam combiner of the present invention is less than the conventional combiner, which may lower the cost.

The description above is a few preferred embodiments of the present invention and the equivalence of the present invention is still in the scope of claim construction of the present invention.

What is claimed is:

1. A beam combiner, comprising:
a splitting film;
a polarization rotator for rotating a polarization angle of a polarized beam, wherein an angle between the splitting film and the polarization rotator is 45 degrees; and
an edge filter film provided on the polarization rotator, wherein the polarization rotator is between the splitting film and the edge filter film.

2. The beam combiner as defined in claim 1, further comprising a prism on which the splitting film is provided.

3. The beam combiner as defined in claim 1, further comprising a transparent plate on which the splitting film is provided.

4. The beam combiner as defined in claim 1, wherein splitting film has both functions of a dichroic splitting film and a polarized splitting film.

5. The beam combiner as defined in claim 1, wherein the polarization rotator is a ¼ waveplate.

6. The beam combiner as defined in claim 2, wherein the splitting film is between the prism and the polarization rotator.

7. The beam combiner as defined in claim 2, wherein the prism is between the splitting film and the polarization rotator.

8. The beam combiner as defined in claim 7, wherein the polarization rotator is attached on the prism.

9. The beam combiner as defined in claim 3, wherein the splitting film is between the prism and the polarization rotator.

10. The beam combiner as defined in claim 1, wherein the beam combiner has three entrances for beams, one of which is substantially perpendicular to the other.
